(19) United States
(12) Patent Application Publication
(10) Pub. No.: US 2025/0355964 A1
(43) Pub. Date: Nov. 20, 2025

(54) PROCESSING MIXED-PRECISION TENSOR WITH PRECISION MAP

(71) Applicant: Microsoft Technology Licensing, LLC, Redmond, WA (US)

(72) Inventors: Mrinal DEO, Sammamish, WA (US); Nitin Naresh GAREGRAT, San Jose, CA (US); Timothy Hume HEIL, Woodinville, WA (US); Xiaoling XU, Cupertino, CA (US)

(73) Assignee: Microsoft Technology Licensing, LLC, Redmond, WA (US)

(21) Appl. No.: 18/664,701

(22) Filed: May 15, 2024

(51) Int. Cl. G06F 17/16

(52) U.S. Cl. CPC G06F 17/16

(57) ABSTRACT

A computing device including memory storing a mixed-precision tensor. The mixed-precision tensor includes one or more first tensor regions within which first tensor elements have a first precision and one or more second tensor regions within which second tensor elements have a second precision. The memory further stores a precision map indicating the first and second tensor regions. The computing device further includes a hardware accelerator configured to receive the precision map and the one or more first tensor regions, as indicated by the precision map, and perform a tensor processing operation on the one or more first tensor regions in the first precision. The hardware accelerator receives the one or more second tensor regions, as indicated by the precision map, and performs the tensor processing operation on the one or more second tensor regions in the second precision. The hardware accelerator stores a combined tensor processing output.

### BACKGROUND

Machine learning models typically utilize data stored in tensor form. For example, the parameters of a machine learning model are typically stored in tensors. When training of the machine learning model or inferencing by the machine learning model is performed, large numbers of matrix operations such as matrix multiplication and addition are performed on the tensor-formatted data.

Specialized hardware accelerators have been developed to more efficiently perform matrix operations that frequently occur in machine learning settings. These hardware accelerators take advantage of the high parallelizability of matrix operations to accelerate those operations by performing component steps in parallel at different processing areas. Accordingly, specialized hardware accelerators reduce the amount of time consumed by those matrix operations.

### SUMMARY

According to one aspect of the present disclosure, a computing device is provided, including memory storing a mixed-precision tensor. The mixed-precision tensor includes one or more first tensor regions within which a plurality of first tensor elements have a first precision. The mixed-precision tensor further includes one or more second tensor regions within which a plurality of second tensor elements have a second precision that differs from the first precision. The memory further stores a precision map indicating the one or more first tensor regions and the one or more second tensor regions. The computing device further includes a hardware accelerator configured to receive the precision map from the memory and receive the one or more first tensor regions from the memory, as indicated by the precision map. The hardware accelerator is further configured to perform a tensor processing operation on the one or more first tensor regions in the first precision to obtain a first tensor processing output. The hardware accelerator is further configured to receive the one or more second tensor regions from the memory, as indicated by the precision map. The hardware accelerator is further configured to perform the tensor processing operation on the one or more second tensor regions in the second precision to obtain a second tensor processing output. The hardware accelerator is further configured to store, in the memory, a combined tensor processing output including the first tensor processing output and the second tensor processing output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing system that includes a hardware accelerator configured to perform a tensor processing operation, according to one example embodiment.

FIG. 2 schematically shows the components included in a tile of the hardware accelerator, according to the example of FIG. 1.

FIG. 3A schematically shows an example of a conventional single-precision tensor, according to the example of FIG. 1.

FIG. 3B schematically shows an example mixed-precision tensor, according to the example of FIG. 1.

FIG. 4 schematically shows the computing device during processing of a mixed-precision tensor in an example in which the hardware accelerator has hardware-level mixed precision support, according to the example of FIG. 1.

FIG. 5 schematically shows the computing device in an example in which the mixed-precision tensor is stored in a plurality of chunks, according to the example of FIG. 1.

FIG. 6A schematically shows an example precision map that includes a respective chunk precision indicator for each chunk of the mixed-precision tensor, according to the example of FIG. 5.

FIG. 6B schematically shows an example precision map that includes respective chunk location indices of chunks that do not have a default precision, according to the example of FIG. 5.

FIG. 7 schematically shows a tile of the hardware accelerator when the tile receives a chunk of the mixed-precision tensor, according to the example of FIG. 2.

FIG. 8 schematically shows a tensor processor of a tile in additional detail, according to the example of FIG. 7.

FIG. 9A shows a flowchart of a method for use at a computing device to perform a mixed-precision tensor processing operation, according to the example of FIG. 1.

FIGS. 9B-9E show additional steps of the method of FIG. 9A that may be performed in some examples.

FIG. 10 shows a schematic view of an example computing environment in which the computing device of FIG. 1 may be instantiated.

### DETAILED DESCRIPTION

Quantization is one technique that is frequently used to reduce the memory and processing costs of machine learning operations. When quantization is performed, stored data is compressed into a lower-precision data type. For example, elements of a tensor that are stored as 32-bit floating-point (fp32) values may be compressed into a precision such as bfloat16, fp16, fp8, or fp4 that uses fewer bits of data to store that tensor element. Quantization allows smaller amounts of memory to be used to store the tensor. In addition, matrix operations performed on the quantized tensor may be performed more quickly.

Quantization incurs a tradeoff between storage/processing costs and the accuracy of matrix operations performed on the quantized data. This loss in accuracy may occur as a result of clipping the dynamic ranges of tensor elements when those tensor elements are quantized. The loss in accuracy due to quantization may lead a machine learning model to produce lower-quality final outputs. The majority of this loss in accuracy is typically the result of quantizing a small number (e.g., 5%) of the elements of the tensor.

Devices and methods are discussed below in which multiple different precisions are used to quantize a tensor. By using multiple different precisions, some elements of the tensor may be represented at high precision while a majority of the tensor elements are quantized to a lower precision. The resulting mixed-precision tensor may accordingly be stored and processed efficiently while also avoiding significant decreases in matrix operation accuracy. However, as discussed in further detail below, software-based approaches to multi-precision quantization would incur significant overhead costs related to tensor sharding and command packet transmission. In order to avoid these overhead costs, the devices and methods discussed below provide hardware-accelerator-level support for mixed-precision tensor operations.

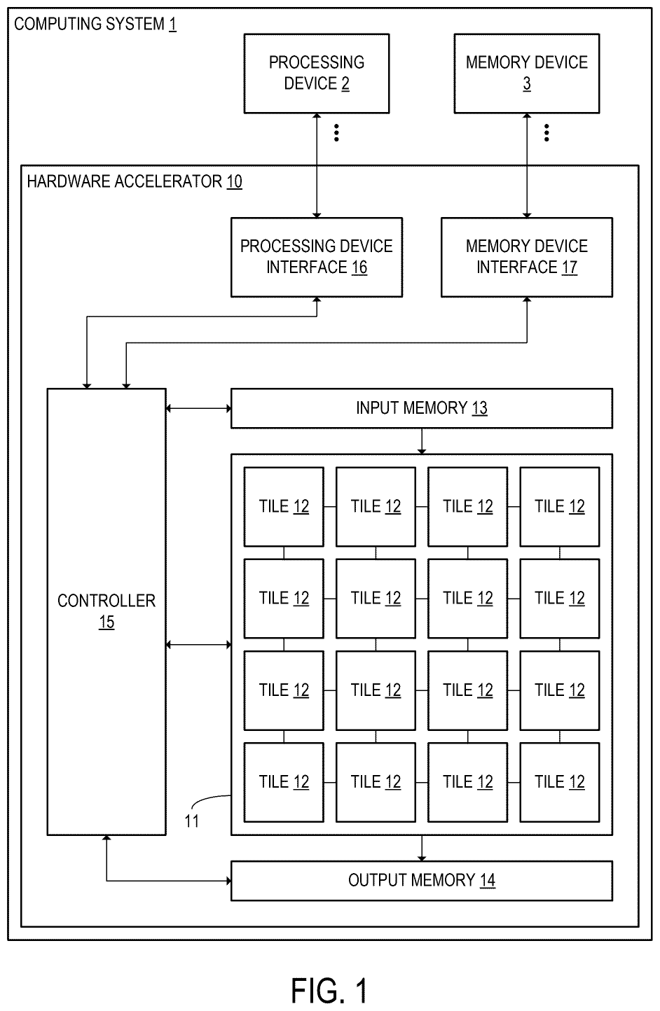

FIG. 1 schematically shows an example computing system 1 that includes a hardware accelerator 10. The hardware accelerator 10 may be included among a plurality of processing devices 2 of the computing system. The plurality of processing devices 2 may further include one or more central processing units (CPUs), application-specific integrated circuits (ASICs), field-programmable gate arrays (FPGAs), other hardware accelerators, and/or other types of processing devices. The computing system 1 further includes memory 3, which is instantiated at one or more memory devices. The one or more memory devices may include one or more volatile memory devices and/or non-volatile storage devices. The computing system 1 may be implemented in a single physical computing device or in a plurality of networked physical computing devices, such as a plurality of server computing devices located in a data center.

The hardware accelerator 10, as shown in the example of FIG. 1, includes processing circuitry 11 at which matrix operations are performed. The processing circuitry 11 in the example of FIG. 1 is arranged in a plurality of tiles 12 that are configured to process respective blocks of matrices, as discussed in further detail below. The plurality of tiles 12 are arranged in a rectangular grid in the example of FIG. 1. The hardware accelerator 10 further includes input memory 13 configured to store inputs to the hardware accelerator 10 and output memory 14 configured to store outputs of the hardware accelerator 10.

In the example of FIG. 1, the hardware accelerator 10 further includes a controller 15 that is configured to schedule and control the flow of data between different regions of the hardware accelerator 10. The example hardware accelerator 10 further includes a processing device interface 16 via which the hardware accelerator 10 is configured to communicate with the one or more additional processing devices 2 of the computing system 1. In addition, the hardware accelerator 10 further includes a memory device interface 17 via which the hardware accelerator 10 is configured to communicate with the one or more memory devices included in the memory 3. For example, the memory device interface 17 may be configured to perform direct memory access (DMA).

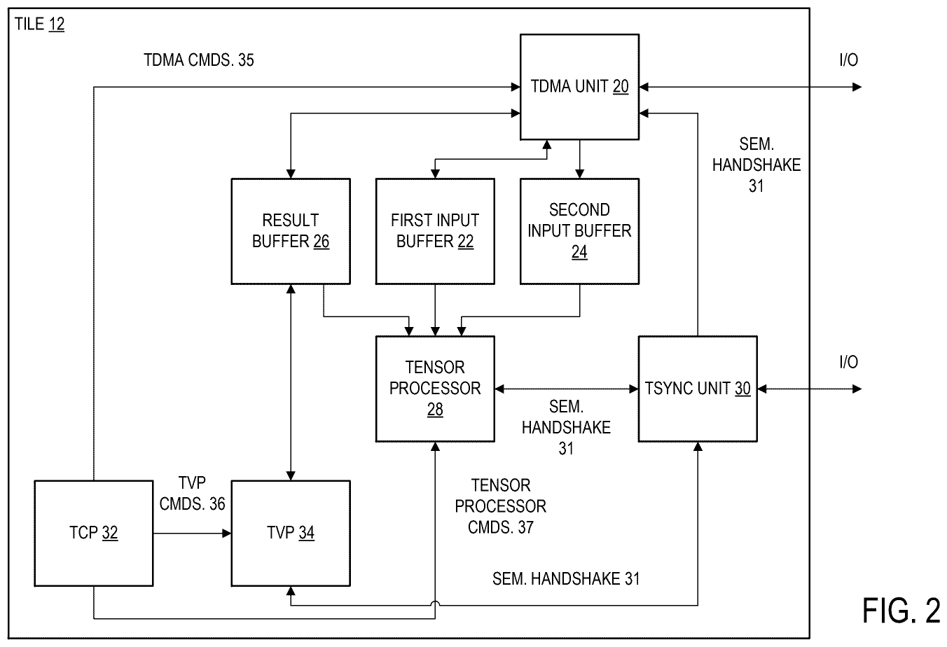

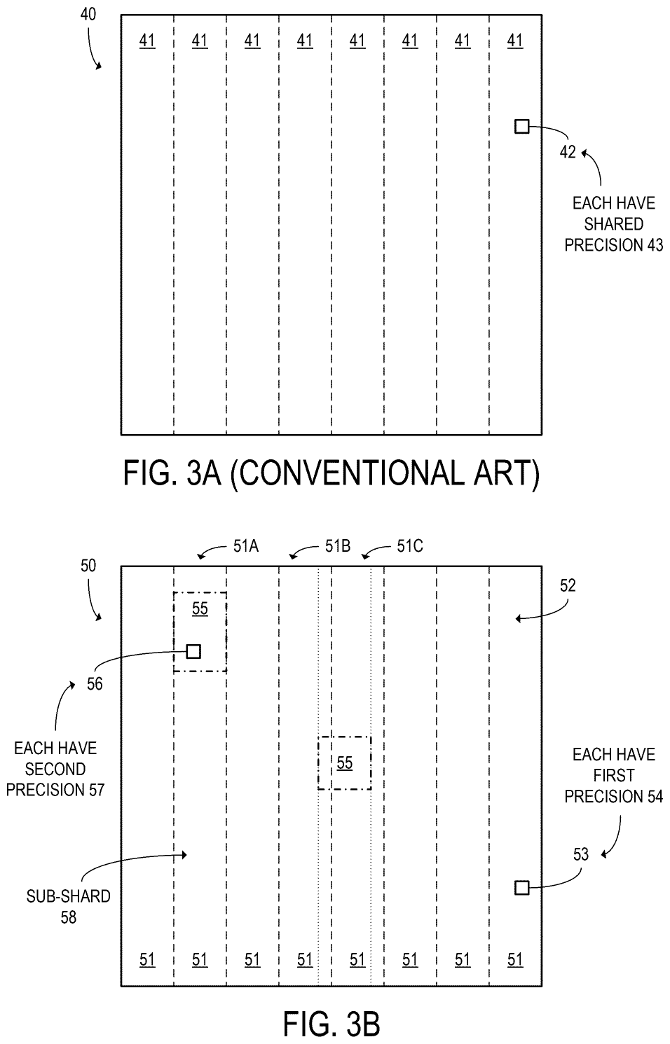

FIG. 2 schematically shows the components included in a tile 12 of the hardware accelerator 10, according to one example. The tile 12 shown in the example of FIG. 3 includes a tile direct memory access (TDMA) unit 20 via which the tile 12 is configured to perform DMA with other components of the hardware accelerator 10. For example, via the TDMA unit 20, the tile 12 may be configured to receive inputs to a matrix multiplication operation.

The tile 12 further includes a plurality of memory buffers, which include a first input buffer 22, a second input buffer 24, and a result buffer 26. The first input buffer 22, the second input buffer 24, and the result buffer 26 may each be tile static random-access memory (TSRAM), which may be level one (L1) memory. In the example of FIG. 2, the first input buffer 22 and the second input buffer 24 are configured to store inputs to a tensor processor 28 at which matrix multiplication is performed, as discussed in further detail below. The result buffer 26 is configured to store the outputs of matrix operations. The first input buffer 22, the second input buffer 24, and the result buffer 26 are configured to communicate with the TDMA unit 20 to send and receive data via DMA.

The tile 12 further includes a tile synchronization (TSYNC) unit 30 that is configured to perform a semaphore handshake 31 between components of the tile 12 and other components of the hardware accelerator 10. The semaphore handshake 31 communicates signals between pairs of components that indicate when those components are ready to consume data. In the example of FIG. 2, endpoints of the semaphore handshake 31 may include the TDMA unit 20 and the tensor processor 28. Each semaphore handshake 31 may be internal to the tile 12 or between a component of the tile 12 and an external component of the hardware accelerator 10. External endpoints may, for example, include other tiles 12, the input memory 13, the output memory 14, and/or the controller 15.

The tile 12 shown in the example of FIG. 2 further includes a tile control processor (TCP) 32 and a tile vector processor (TVP) 34. The TCP 32 is configured to execute a kernel that instructs the TCP 32 to transmit commands to other components of the tile. Thus, the TCP 32 is configured to transmit TDMA commands 35 to the TDMA unit 20, TVP commands 36 to the TVP 34, and tensor processor commands 37 to the tensor processor 28. The TVP 34 is a within-tile hardware accelerator that is configured to perform one or more predefined vector operations on vectors stored in the result buffer 26. For example, the TVP 34 may be configured to apply an activation function or a SoftMax function to a vector stored in the result buffer 26. The TCP 32 and the TVP 34 may be endpoints of semaphore handshakes 31, as shown in the example of FIG. 2.

FIG. 3A schematically shows an example of a conventional single-precision tensor 40 that may be stored in the memory 3. In the example of FIG. 3A, the single-precision tensor 40 includes a plurality of single-precision tensor elements 42 that each have a shared precision 43. The single-precision tensor 40 is divided into a plurality of single-precision shards 41, which are column-wise shards in the example of FIG. 3A. The hardware accelerator 10 is configured to process the single-precision shards 41 serially such that a memory bandwidth of the hardware accelerator 10 is not exceeded.

FIG. 3B shows an example mixed-precision tensor 50 that may be stored in the memory 3. The mixed-precision tensor 50 of FIG. 3B includes a first tensor region 52 within which a plurality of first tensor elements 53 have a first precision 54. The mixed-precision tensor 50 further includes second tensor regions 55 within which a plurality of second tensor elements 56 have a second precision 57 that differs from the first precision 54. The mixed-precision tensor 50 may also be stored in the memory 3 in a plurality of shards 51. However, as shown in the example of FIG. 3B, one or more respective tensor region boundaries of the one or more first tensor regions 52 differ from respective shard boundaries of the plurality of shards 51.

According to software-based approaches to mixed-precision tensor processing, the shards 51 of the mixed-precision tensor 50 would have to be subdivided into a larger number of serially processed sub-shards 58. In the example of FIG. 3B, these sub-shards 58 would include portions of the second-leftmost shard 51A above, at, and below, the second tensor region 55 located in that column. The middle two shards 51B and 51C depicted in FIG. 3B would be divided vertically as well as horizontally, since a second tensor region 55 extends across the middle two shards 51B and 51C but does not extend the entire width of either of those shards. The middle two of the four resulting sub-shards 58 would be further divided into sub-shards 58 above, at, and below the second tensor region 55. Thus, misalignment between the second tensor regions 55 and the shard boundaries would lead to a significant slowdown in tensor processing due to the resulting increase in the number of serially processed regions of the mixed-precision tensor 50. Dividing the mixed-precision tensor 50 into a large number of sub-shards 58 would also significantly increase the number of tensor processor commands 37 passed from the TCP 32 to the tensor processor 28, thereby resulting in an additional slowdown.

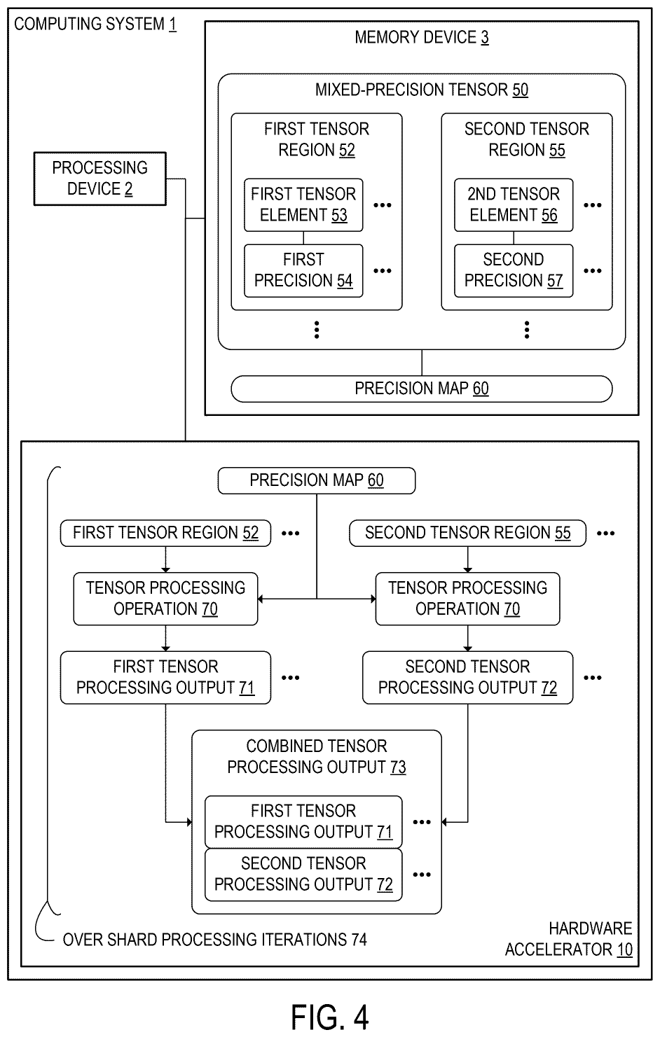

FIG. 4 schematically shows the computing device 1 during processing of a mixed-precision tensor 50 in an example in which the hardware accelerator 10 has hardware-level mixed precision support. As discussed above, the mixed-precision tensor 50 includes one or more first tensor regions 52 within which a plurality of first tensor elements 53 have a first precision 54, as well as one or more second tensor regions 55 within which a plurality of second tensor elements 56 have a second precision 57 that differs from the first precision 54. In some examples, although not shown in FIG. 4, three or more different precisions are used within the mixed-precision tensor 50.

In addition to the mixed-precision tensor 50, the memory 3 further stores a precision map 60 indicating the one or more first tensor regions 52 and the one or more second tensor regions 55. When the mixed-precision tensor 50 is processed, as shown in the example of FIG. 4, the hardware accelerator 10 is configured to receive the precision map 60 from the memory 3. The hardware accelerator 10 is further configured to refer to the precision map 60 in order to schedule retrieval of tensor values. The hardware accelerator 10 is accordingly further configured to receive the one or more first tensor regions 52 from the memory 3, as indicated by the precision map 60, and to perform a tensor processing operation 70 on the one or more first tensor regions 52 in the first precision 54. The hardware accelerator is accordingly configured to obtain a first tensor processing output 71. The one or more first tensor regions 52 may be received at the input memory 13 via the memory device interface 17 and processed at the processing circuitry 11. The tensor processing operation 70 may, for example, be a matrix multiplication operation, an elementwise addition operation, or some other type of tensor processing operation.

The hardware accelerator 10 is further configured to receive the one or more second tensor regions 55 from the memory 3, as indicated by the precision map 60. The hardware accelerator 10 is further configured to perform the tensor processing operation 70 on the one or more second tensor regions 55 in the second precision 57 to obtain a second tensor processing output 72. The one or more second tensor regions 55 may be received at the input memory 13 via the memory device interface 17 and processed at the processing circuitry 11.

The tensor processing operation 70 may be performed on the one or more first tensor regions 52 and the one or more second tensor regions 55 in parallel. In such examples, different tiles 12 of the processing circuitry 11 are configured to perform the tensor processing operation 70 at different respective precisions. This parallelization allows for faster processing compared to the serial sub-shard processing discussed above with reference to FIG. 3B.

The hardware accelerator 10 is further configured to store, in the memory 3, a combined tensor processing output 73 including the first tensor processing output 71 and the second tensor processing output 72. The combined tensor processing output 73 may be initially stored in the output memory 14 of the hardware accelerator 10 and output to the memory 3 via the memory device interface 17.

In the example of FIG. 4, the hardware accelerator 10 is further configured to receive the shards 51 during separate shard processing iterations 74. During each shard processing iteration 74, the hardware accelerator 10 may be configured to compute a corresponding shard of the combined tensor processing output 73. For example, the shard of the combined tensor processing output 73 may be computed as a matrix product of the shard 51 of the mixed-precision tensor 50 and a shard of an additional tensor. Thus, the hardware accelerator 10 may be configured to iteratively compute the combined tensor processing output 73 over the plurality of shard processing iterations 74. Each shard 51 of mixed-precision tensor 50 may be processed in the corresponding shard processing iteration 74 without subdivision into serially processed sub-shards 58. Thus, the hardware accelerator 10 may be configured combined tensor processing output 73 in a shorter amount of time.

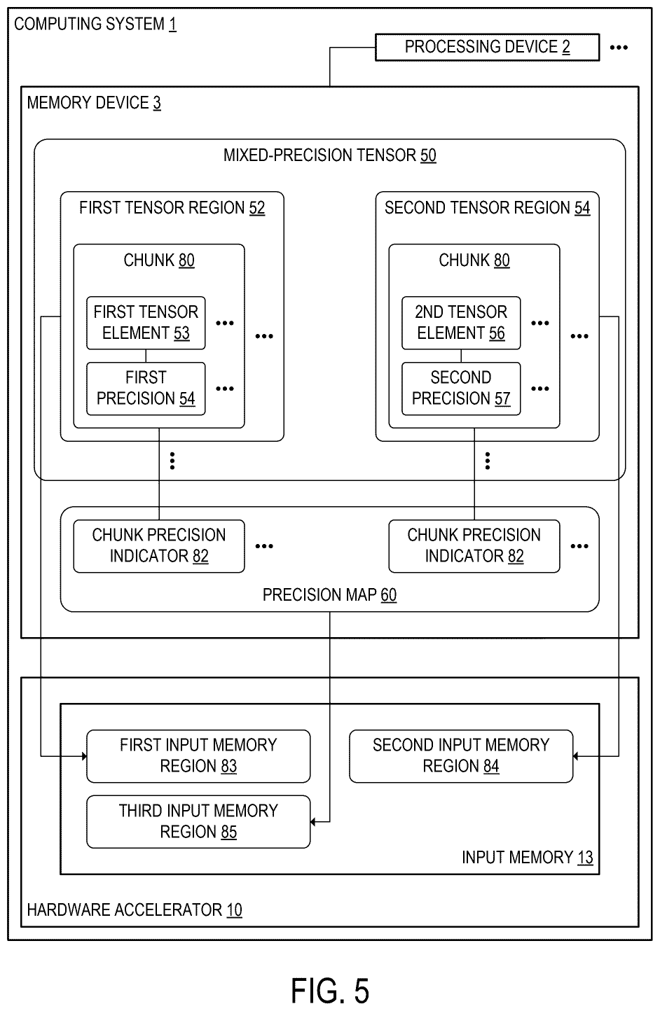

FIG. 5 schematically shows the computing device 1 in an example in which the mixed-precision tensor 50 is stored in a plurality of chunks 80. The plurality of chunks 80 may each have a predefined chunk size, such as, for example, 16×16, 32×32, or 64×64 tensor elements. In the example of FIG. 5, the precision map 60 is stored as an array of chunk precision indicators 82 associated with respective chunks 80 of the mixed-precision tensor 50. The chunk precision indicators 82 specify the precisions of the chunks 80.

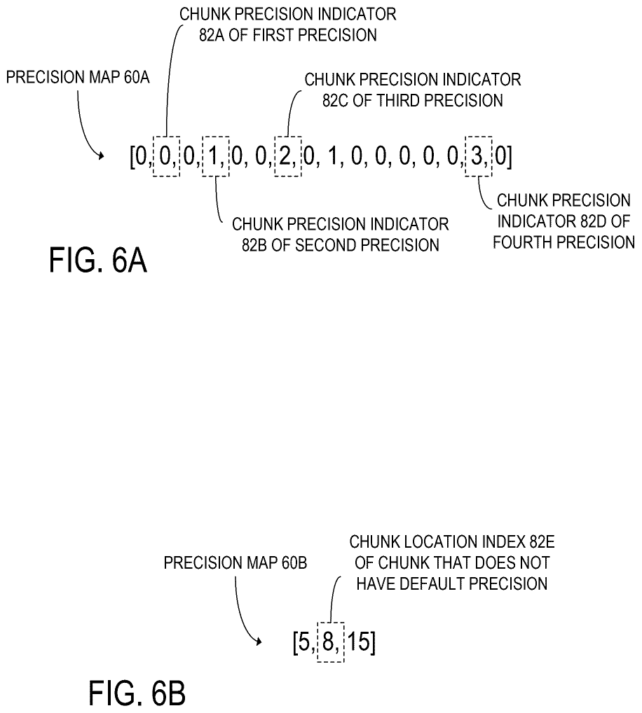

FIGS. 6A and 6B show two example structures of the precision map 60. FIG. 6A shows a precision map 60A of an example mixed-precision tensor 50 that includes four different precisions. The precision map 60A includes a respective chunk precision indicator 82 associated with each of the plurality of chunks 80 included in the mixed-precision tensor 50. Thus, the example precision map 60A includes a plurality of chunk precision indicators 82A of the first precision 54, a plurality of chunk precision indicators 82B of the second precision 57, a chunk precision indicator 82C of the third precision, and a chunk precision indicator 82D of the third precision.

FIG. 6B shows an example precision map 60B for a mixed-precision tensor 50 in which the first precision 54 is a default precision of tensor elements included in the mixed-precision tensor 50. In the example of FIG. 6B, two different precisions are used to quantize the mixed-precision tensor 50. The precision map 60B includes chunk location indices 82E of respective chunks 80 that do not have the default precision. The chunk location indices 82E each refer to respective chunk locations within the mixed-precision tensor 50. The precision map 60B may allow less memory to be used to store the precision map 60B in examples in which two different precisions are used in the mixed-precision tensor 50.

Returning to the example of FIG. 5, the input memory 13 of the hardware accelerator 10 is schematically depicted when the mixed-precision tensor 50 and the precision map 60 are stored. The input memory 13, as shown in the example of FIG. 5, stores the one or more first tensor regions 52 and the one or more second tensor regions 55 in different respective non-interleaved memory regions. FIG. 5 shows a first input memory region 83 and a second input memory region 84 that store the one or more first tensor regions 52 and the one or more second tensor regions 55, respectively, without the one or more first tensor regions 52 and the one or more second tensor regions 55 being interleaved with each other. FIG. 5 further shows a third input memory region 85 in which the precision map 60 is stored. The memory device interface 17 of the hardware accelerator 10 is accordingly configured to separate one or more first tensor regions 52 from the one or more second tensor regions 55 when the mixed-precision tensor 50 is loaded into the input memory 13. By avoiding interleaving, the one or more first tensor regions 52 and the one or more second tensor regions 55 may be packed more tightly in the input memory 13, since holes may occur in the memory layout of the input memory 13 when multiple different precisions are interspersed.

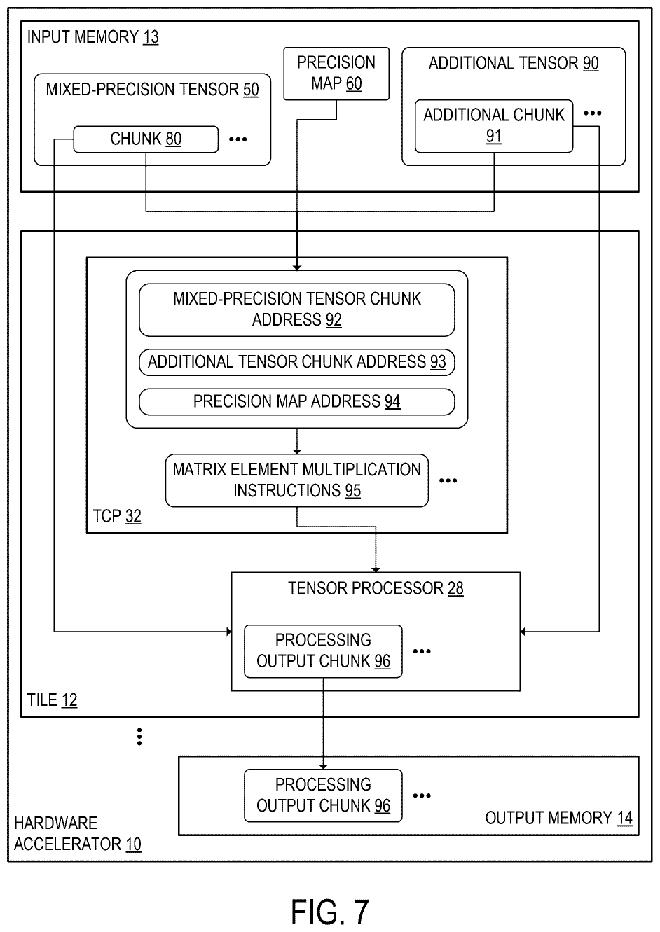

FIG. 7 schematically shows a tile 12 of the hardware accelerator 10 when the tile 12 receives a chunk 80 of the mixed-precision tensor 50. The tile 12 further receives the precision map 60 and an additional chunk 91 of an additional tensor 90 in the example of FIG. 7. In this example, the tile 12 included in the hardware accelerator 10 is configured to multiply the chunk 80 of the mixed-precision tensor 50 by the additional chunk 91 of the additional tensor 90 to compute a processing output chunk 96. The tile 12 is further configured to output the processing output chunk 96 to the output memory 14 of the hardware accelerator 10.

The TCP 32 included in the tile 12 may be configured to receive respective addresses in the input memory 13 of the chunk 80 of the mixed-precision tensor 50, the additional chunk 91 of the additional tensor 90, and the precision map 60. Thus, the TCP 32 is shown in the example of FIG. 7 receiving a mixed-precision tensor chunk address 92, an additional tensor chunk address 93, and a precision map address 94. Based at least in part on the mixed-precision tensor chunk address 92, the additional tensor chunk address 93, and the precision map address 94, the TCP 32 is further configured to compute respective matrix element multiplication instructions 95. The matrix element multiplication instructions 95 may specify a pair of tensor elements respectively included in the chunk 80 and the additional chunk 91, as well as the chunk precision indicator 82 associated with the chunk 80.

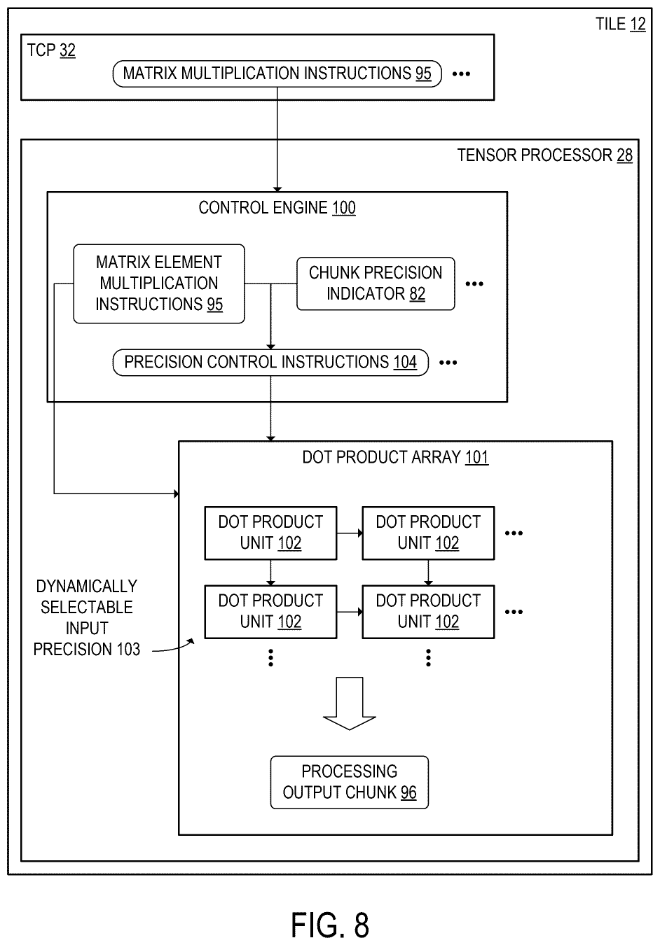

FIG. 8 schematically shows the tensor processor 28 of the tile 12 in additional detail. As shown in the example of FIG. 8, the TCP 32 is further configured to transmit the matrix element multiplication instructions 95 to a plurality of control engines 100 included in the hardware accelerator 10. The control engines 100, as shown in the example of FIG. 8, are included in the respective tensor processors 28 of the tiles 12. Each tensor processor 28 further includes a plurality of dot product units 102 arranged in a dot product array 101. The dot product array 101 is a systolic array in the example of FIG. 8. At the plurality of dot product units 102 included in the dot product array 101, the hardware accelerator 10 is configured to compute a respective plurality of dot products in parallel when performing the matrix multiplication operation. The processing output chunk 96 includes the results of these dot products.

As shown in the example of FIG. 8, the control engine 100 may be configured to compute respective precision control instructions 104 for the dot product units 102 included in the dot product array 101. The control engine 100 may be configured to compute the precision control instructions based at least in part on the chunk precision indicator 82 of the chunk 80 processed at the tile 12. The chunk precision indicator 82 may be received from the input memory 13 of the hardware accelerator 10 as indicated by the location in the precision map 60 indicated in the matrix element multiplication instructions 95. The control engine 100 is further configured to transmit the matrix element multiplication instructions 95 and the precision control instructions 104 to the corresponding dot product units 102 included in the dot product array 101.

The dot product units 102 have dynamically selectable input precisions 103 that are configured to be selectable via the precision control instructions 104. Accordingly, each dot product unit 102 is configured to multiply a corresponding element of the chunk 80 by a corresponding element of the additional chunk 91 with the specified precision of the chunk 80, as indicated in the precision control instructions 104.

As discussed above with reference to FIG. 1, the hardware accelerator 10 includes a plurality of tiles 12 in its processing circuitry 11. By multiplying chunks 80 of the mixed-precision tensor 50 by additional chunks 91 of the additional tensor 90 at respective tiles 12, the hardware accelerator 10 is configured to compute the combined tensor processing output 73 as the product of the mixed-precision tensor 50 and the additional tensor 90.

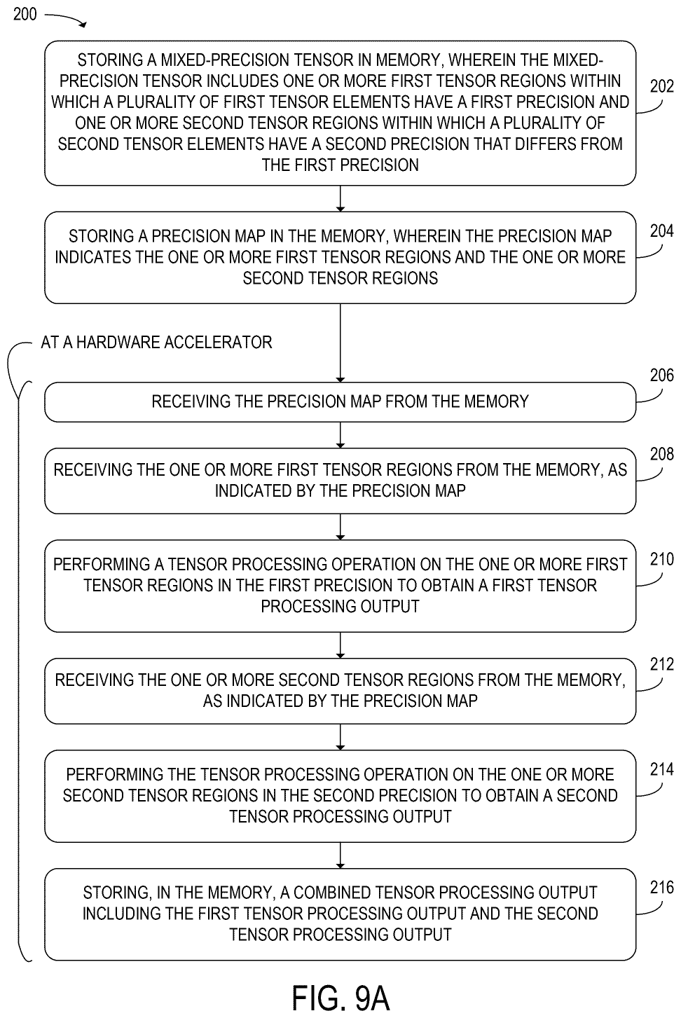

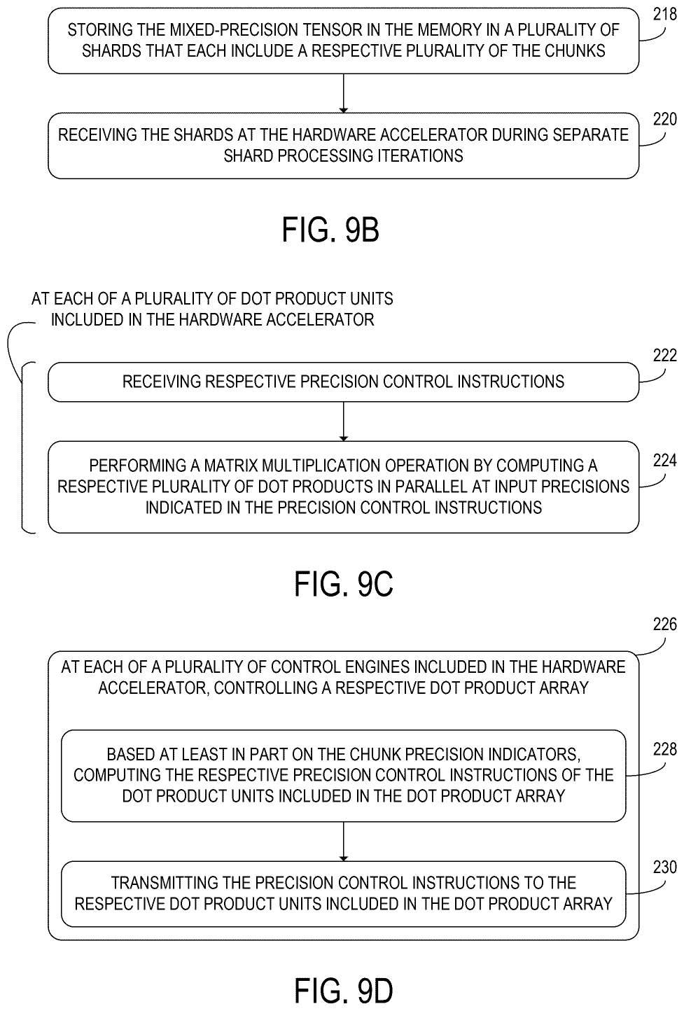

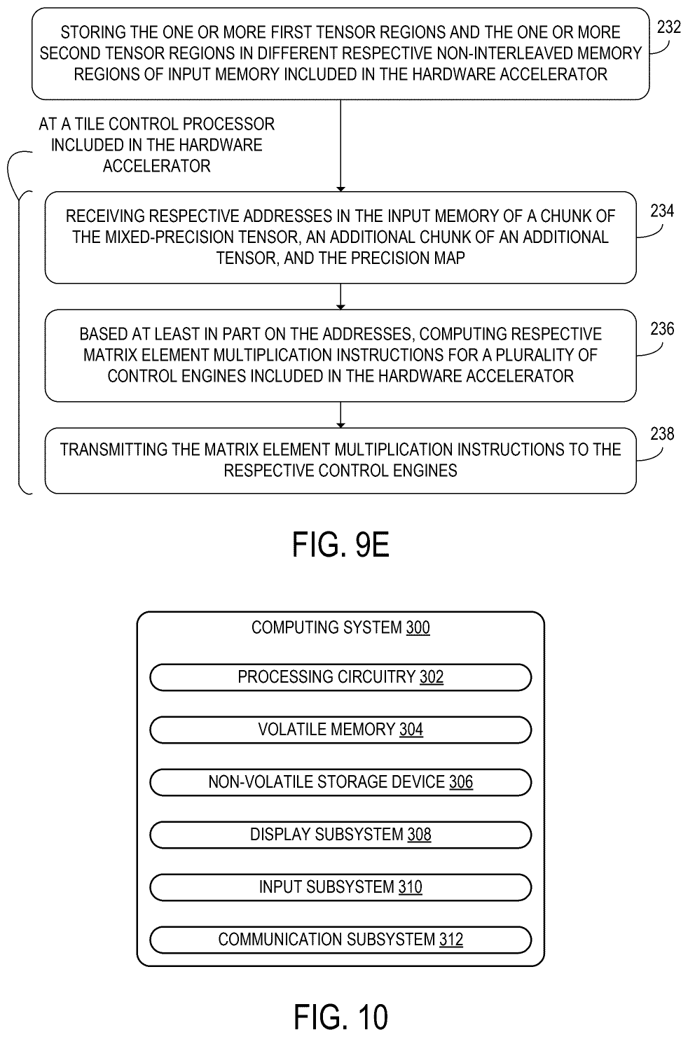

FIG. 9A shows a flowchart of a method 200 for use at a computing device to perform a mixed-precision tensor processing operation. At step 202, the method 200 includes storing a mixed-precision tensor in memory. The mixed-precision tensor includes one or more first tensor regions within which a plurality of first tensor elements have a first precision. In addition, the mixed-precision tensor includes one or more second tensor regions within which a plurality of second tensor elements have a second precision that differs from the first precision. For example, the first precision and the second precision may each be selected from the group consisting of bfloat16, fp32, fp16, fp8, and fp4. In other examples, the first tensor elements and/or the second tensor elements may have some other precision. The tensor elements of the mixed-precision tensor may have three or more different precisions in some examples. In some examples, the mixed-precision tensor is stored as a plurality of chunks that each have a predefined chunk size. For example, the predefined chunk size may be 16×16, 32×32, or 64×64.

At step 204, the method 200 further includes storing a precision map in the memory. The precision map indicates the one or more first tensor regions and the one or more second tensor regions. In examples in which the mixed-precision tensor is stored in a plurality of chunks, the precision map may be stored as an array of chunk precision indicators associated with respective chunks of the mixed-precision tensor. For example, the precision map may include a respective chunk precision indicator associated with each of the plurality of chunks included in the mixed-precision tensor. Alternatively, in examples in which the first precision is a default precision of tensor elements included in the mixed-precision tensor, the precision map may includes one or more chunk location indices of respective chunks that do not have the default precision.

Steps 206, 208, 210, 212, 214, and 216 of the method 200 are performed at a hardware accelerator included in the computing device. At step 206, the method 200 includes receiving the precision map from the memory. In addition, at step 208, the method 200 further includes receiving the one or more first tensor regions from the memory, as indicated by the precision map. The method 200 further includes, at step 210, performing a tensor processing operation on the one or more first tensor regions in the first precision to obtain a first tensor processing output. For example, the tensor processing operation may be a matrix multiplication operation. The hardware accelerator may compute the first tensor processing output with the first precision indicated by the chunk precision indicators associated with the one or more first tensor regions.

At step 212, the method 200 further includes receiving the one or more second tensor regions from the memory, as indicated by the precision map. At step 214, the method 200 further includes performing the tensor processing operation on the one or more second tensor regions in the second precision to obtain a second tensor processing output. The second tensor processing output may accordingly be computed with the second tensor precision indicated in the chunk precision indicators associated with the second tensor regions.

Steps 208 and 210 may be performed in parallel with steps 212 and 214 at different portions of the processing circuitry of the hardware accelerator. Thus, rather than dividing the mixed-precision tensor into a potentially large number of regions that are processed serially, the hardware accelerator may save processing time by computing tensor processing outputs with different precisions in parallel.

At step 216, the method 200 further includes storing, in the memory, a combined tensor processing output including the first tensor processing output and the second tensor processing output. The combined tensor processing output is the result of performing the tensor processing operation on the entire mixed-precision tensor. For example, the combined tensor processing result may be a product tensor computed by multiplying the mixed-precision tensor and an additional tensor.

FIGS. 9B-9E show additional steps of the method 200 of FIG. 9A that may be performed in some examples. FIG. 9B shows steps that may be performed when the mixed-precision tensor is stored in a plurality of chunks. At step 218, the method 200 may further include storing the mixed-precision tensor in the memory in a plurality of shards that each include a respective plurality of the chunks. For example, the shards may be column-wise or row-wise shards of the mixed-precision tensor. Each shard may include tensor elements with one or more precisions. Thus, in some examples, one or more respective tensor region boundaries of the one or more first tensor regions may differ from respective shard boundaries of the plurality of shards.

At step 220, the method 200 may further include receiving the shards at the hardware accelerator during separate shard processing iterations. By processing the shards at separate shard processing iterations, the hardware accelerator may process a mixed-precision tensor that exceeds a memory bandwidth of the hardware accelerator in size.

FIG. 9C shows steps that may be performed in examples in which the tensor processing operation is a matrix multiplication operation, and in which the hardware accelerator includes a plurality of dot product units. For example, the dot product units may be arranged in a plurality of dot product arrays that are included in respective tiles of the hardware accelerator. The dot product arrays may, for example, be systolic arrays. At step 222, the method 200 may further include receiving respective precision control instructions at the dot product units. At step 224, the method 200 may further include performing the matrix multiplication operation at the dot product units by computing a respective plurality of dot products in parallel. The dot products are computed at input precisions indicated in the precision control instructions. The dot product units accordingly compute the elements of the first tensor processing output and the second tensor processing output.

FIG. 9D shows additional steps of the method 200 that may be performed in some examples in which the steps of FIG. 9C are performed. The hardware accelerator further includes a plurality of control engines in the example of FIG. 9D. At step 226, the method 200 may further include, at each of the control engines, controlling a respective dot product array. A dot product array and a corresponding control engine may be included in each tile of the hardware accelerator. The dot products included in the dot product array may be used to compute a respective plurality of dot products in parallel when performing a matrix multiplication operation.

At step 228, step 226 may include computing the respective precision control instructions of the dot product units included in the dot product array based at least in part on the chunk precision indicators. At step 230, step 226 may further include transmitting the precision control instructions to the respective dot product units included in the dot product array. Accordingly, the control engine may set a dynamically selectable input precision of the dot product units included in the corresponding dot product array.

FIG. 9E shows additional steps of the method 200 that may be performed in some examples. At step 232, the method 200 may further include storing the one or more first tensor regions and the one or more second tensor regions in different respective non-interleaved memory regions of input memory included in the hardware accelerator. The precision map may also be stored in a region of the input memory that is not interleaved with the memory region storing the one or more first tensor regions or the memory region storing the one or more second tensor regions. Tighter packing of the input memory may be achieved by avoiding interleaving.

Steps 234, 236, and 238 of FIG. 9E may be performed at a tile control processor included in the hardware accelerator. For example, a respective tile control processor may be included in each tile. At the tile control processor, the method 200 may further include, at step 234, receiving respective addresses in the input memory of a chunk of the mixed-precision tensor, an additional chunk of an additional tensor, and the precision map. The additional tensor is a tensor by which the hardware accelerator is configured to multiply the mixed-precision tensor.

At step 236, the method 200 may further include computing respective matrix element multiplication instructions for a plurality of control engines included in the hardware accelerator. The matrix element multiplication instructions are computed based at least in part on the addresses. At step 238, the method 200 may further include transmitting the matrix element multiplication instructions to the respective control engines. The tensor control processor may thereby provide, to the control engines, instructions to retrieve and multiply specific chunks of the mixed-precision tensor and the additional tensor, as indicated by the addresses of those chunks in the memory. The control engines may also receive the address of the precision map and use the chunk precision indicators stored in the precision map to compute the precision control instructions as discussed above.

Using the devices and methods discussed above, hardware-level support is provided for matrix operations performed on mixed-precision tensors. This hardware-level support allows a mixed-precision tensor to be processed, e.g. in a matrix multiplication operation, in a manner that allows the hardware accelerator to process tensor regions with different precisions in parallel. This increased parallelization allows the hardware accelerator to perform matrix multiplication operations on a mixed precision tensor in approximately half the amount of time consumed by performing such a multiplication operation using conventional techniques. Accordingly, the devices and methods discussed above allow for increased use of mixed-precision quantization in machine learning settings without incurring large increases in processing time. By making greater use of mixed-precision quantization, machine learning model training and inferencing may be performed more quickly and with reduced processing costs while maintaining the accuracy of model outputs.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 300 that can enact one or more of the methods and processes described above. Computing system 300 is shown in simplified form. Computing system 300 may embody the computing device 1 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 10.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing device is provided, including memory storing a mixed-precision tensor. The mixed-precision tensor includes one or more first tensor regions within which a plurality of first tensor elements have a first precision and one or more second tensor regions within which a plurality of second tensor elements have a second precision that differs from the first precision. The memory further stores a precision map indicating the one or more first tensor regions and the one or more second tensor regions. The computing device further includes a hardware accelerator configured to receive the precision map from the memory. The hardware accelerator is further configured to receive the one or more first tensor regions from the memory, as indicated by the precision map. The hardware accelerator is further configured to perform a tensor processing operation on the one or more first tensor regions in the first precision to obtain a first tensor processing output. The hardware accelerator is further configured to receive the one or more second tensor regions from the memory, as indicated by the precision map. The hardware accelerator is further configured to perform the tensor processing operation on the one or more second tensor regions in the second precision to obtain a second tensor processing output. The hardware accelerator is further configured to store, in the memory, a combined tensor processing output including the first tensor processing output and the second tensor processing output. The above features may have the technical effect of performing parallel processing, at the same hardware accelerator, of tensor regions that have different precisions. This hardware-level parallelization mixed-precision tensor processing may allow for increases in processing efficiency due to quantization without significantly degrading neural network output quality.

According to this aspect, the precision map may be stored as an array of chunk precision indicators associated with respective chunks of the mixed-precision tensor. The plurality of chunks may each have a predefined chunk size. The above features may have the technical effect of specifying the precisions of different portions of the tensor.

According to this aspect, the tensor processing operation may be a matrix multiplication operation. The hardware accelerator may include a plurality of dot product units configured to compute a respective plurality of dot products in parallel when performing the matrix multiplication operation. The dot product units may have dynamically selectable input precisions that are configured to be selectable via precision control instructions. The above features may have the technical effect of providing parallel, hardware-level control of the precisions used when processing different portions of the mixed-precision tensor.

According to this aspect, the dot product units may be arranged in a plurality of dot product arrays. The hardware accelerator may further include a plurality of control engines that are each configured to control a respective dot product array at least in part by, based at least in part on the chunk precision indicators, computing the respective precision control instructions of the dot product units included in the dot product array. Controlling the dot product array may further include transmitting the precision control instructions to the respective dot product units included in the dot product array. The above features may have the technical effect of allowing the control engines to independently control the different dot product arrays.

According to this aspect, the mixed-precision tensor may be stored in the memory in a plurality of shards that each include a respective plurality of the chunks. The hardware accelerator may be further configured to receive the shards during separate shard processing iterations. The above features may have the technical effect of allowing the hardware accelerator to process a tensor that exceeds its input memory bandwidth in size.

According to this aspect, one or more respective tensor region boundaries of the one or more first tensor regions may differ from respective shard boundaries of the plurality of shards. The above features may have the technical effect of allowing for greater flexibility in the precision settings for the different regions of the mixed-precision tensor.

According to this aspect, the precision map may include a respective chunk precision indicator associated with each of the plurality of chunks included in the mixed-precision tensor. The above features may have the technical effect of storing metadata indicating the precisions of the different chunks.

According to this aspect, the first precision may be a default precision of tensor elements included in the mixed-precision tensor. The precision map may include one or more chunk location indices of respective chunks that do not have the default precision. The above features may have the technical effect of storing the precision map in a compressed form when the mixed-precision tensor includes a small number of the second tensor elements that have the second precision.

According to this aspect, the hardware accelerator may include input memory that stores the one or more first tensor regions and the one or more second tensor regions in different respective non-interleaved memory regions. The above features may have the technical effect of allowing the mixed-precision tensor to be packed more tightly in the input memory.

According to this aspect, the hardware accelerator may include a tile control processor configured to receive respective addresses in the input memory of a chunk of the mixed-precision tensor, an additional chunk of an additional tensor, and the precision map. Based at least in part on the addresses, the tile control processor may be further configured to compute respective matrix element multiplication instructions for a plurality of control engines included in the hardware accelerator. The tile control processor may be further configured to transmit the matrix element multiplication instructions to the respective control engines. The above features may have the technical effect of providing parallel, hardware-level control of input fetching performed by the control engines.

According to another aspect of the present disclosure, a method for use with a computing device is provided. The method includes storing a mixed-precision tensor in memory. The mixed-precision tensor includes one or more first tensor regions within which a plurality of first tensor elements have a first precision and one or more second tensor regions within which a plurality of second tensor elements have a second precision that differs from the first precision. The method further includes storing a precision map in the memory. The precision map indicates the one or more first tensor regions and the one or more second tensor regions. The method further includes, at a hardware accelerator, receiving the precision map from the memory, receiving the one or more first tensor regions from the memory, as indicated by the precision map, and performing a tensor processing operation on the one or more first tensor regions in the first precision to obtain a first tensor processing output. The method further includes, at the hardware accelerator, receiving the one or more second tensor regions from the memory, as indicated by the precision map, and performing the tensor processing operation on the one or more second tensor regions in the second precision to obtain a second tensor processing output. The method further includes storing, in the memory, a combined tensor processing output including the first tensor processing output and the second tensor processing output. The above features may have the technical effect of performing parallel processing, at the same hardware accelerator, of tensor regions that have different precisions. This hardware-level parallelization mixed-precision tensor processing may allow for increases in processing efficiency due to quantization without significantly degrading neural network output quality.

According to this aspect, the precision map may be stored as an array of chunk precision indicators associated with respective chunks of the mixed-precision tensor. The plurality of chunks may each have a predefined chunk size. The above features may have the technical effect of specifying the precisions of different portions of the tensor.

According to this aspect, the tensor processing operation may be a matrix multiplication operation. The hardware accelerator may include a plurality of dot product units. The method may further include, at the dot product units, receiving respective precision control instructions. The method may further include, at the dot product units, performing the matrix multiplication operation by computing a respective plurality of dot products in parallel at input precisions indicated in the precision control instructions. The above features may have the technical effect of providing parallel, hardware-level control of the precisions used when processing different portions of the mixed-precision tensor.

According to this aspect, the dot product units are arranged in a plurality of dot product arrays. The hardware accelerator may further include a plurality of control engines. The method may further include, at each of the control engines, controlling a respective dot product array at least in part by computing the respective precision control instructions of the dot product units included in the dot product array based at least in part on the chunk precision indicators. Controlling the dot product array may further include transmitting the precision control instructions to the respective dot product units included in the dot product array. The above features may have the technical effect of allowing the control engines to independently control the different dot product arrays.

According to this aspect, the method may further include storing the mixed-precision tensor in the memory in a plurality of shards that each include a respective plurality of the chunks. The method may further include receiving the shards at the hardware accelerator during separate shard processing iterations. The above features may have the technical effect of allowing the hardware accelerator to process a tensor that exceeds its input memory bandwidth in size.

According to this aspect, the precision map may include a respective chunk precision indicator associated with each of the plurality of chunks included in the mixed-precision tensor. The above features may have the technical effect of storing metadata indicating the precisions of the different chunks.

According to this aspect, the first precision may be a default precision of tensor elements included in the mixed-precision tensor. The precision map may include one or more chunk location indices of respective chunks that do not have the default precision. The above features may have the technical effect of storing the precision map in a compressed form when the mixed-precision tensor includes a small number of the second tensor elements that have the second precision.

According to this aspect, the method may further include storing the one or more first tensor regions and the one or more second tensor regions in different respective non-interleaved memory regions of input memory included in the hardware accelerator. The above features may have the technical effect of allowing the mixed-precision tensor to be packed more tightly in the input memory.

According to this aspect, the hardware accelerator may include a tile control processor. The method may further include, at the tile control processor, receiving respective addresses in the input memory of a chunk of the mixed-precision tensor, an additional chunk of an additional tensor, and the precision map. The method may further include computing respective matrix element multiplication instructions for a plurality of control engines included in the hardware accelerator based at least in part on the addresses. The method may further include transmitting the matrix element multiplication instructions to the respective control engines. The above features may have the technical effect of providing parallel, hardware-level control of input fetching performed by the control engines.

According to another aspect of the present disclosure, a computing device is provided, including memory storing a mixed-precision tensor stored in a plurality of chunks that each have a predefined chunk size. The mixed-precision tensor includes one or more first tensor regions within which a plurality of first tensor elements have a first precision and one or more second tensor regions within which a plurality of second tensor elements have a second precision that differs from the first precision. The memory further stores a precision map indicating the one or more first tensor regions and the one or more second tensor regions. The precision map is stored as an array of chunk precision indicators associated with respective chunks of the mixed-precision tensor. The computing device further includes a hardware accelerator including a plurality of tiles. The hardware accelerator is configured to receive the precision map from the memory, receive the one or more first tensor regions from the memory, as indicated by the precision map, and perform a tensor processing operation on the one or more first tensor regions to obtain a first tensor processing output. The tiles are configured to process respective chunks of the one or more first tensor regions at the first precision. The hardware accelerator is further configured to receive the one or more second tensor regions from the memory, as indicated by the precision map, and perform the tensor processing operation on the one or more second tensor regions to obtain a second tensor processing output. The tiles are configured to process respective chunks of the one or more second tensor regions at the second precision. The hardware accelerator is further configured to store, in the memory, a combined tensor processing output including the first tensor processing output and the second tensor processing output. The above features may have the technical effect of performing parallel processing, at the same hardware accelerator, of tensor regions that have different precisions. This hardware-level parallelization mixed-precision tensor processing may allow for increases in processing efficiency due to quantization without significantly degrading neural network output quality.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
memory storing:
a mixed-precision tensor, wherein the mixed-precision tensor includes:
one or more first tensor regions within which a plurality of first tensor elements have a first precision; and
one or more second tensor regions within which a plurality of second tensor elements have a second precision that differs from the first precision; and
a precision map indicating the one or more first tensor regions and the one or more second tensor regions; and
a hardware accelerator configured to:
receive the precision map from the memory;
receive the one or more first tensor regions from the memory, as indicated by the precision map;
perform a tensor processing operation on the one or more first tensor regions in the first precision to obtain a first tensor processing output;
receive the one or more second tensor regions from the memory, as indicated by the precision map;
perform the tensor processing operation on the one or more second tensor regions in the second precision to obtain a second tensor processing output; and
store, in the memory, a combined tensor processing output including the first tensor processing output and the second tensor processing output.

2. The computing device of claim 1, wherein:
the precision map is stored as an array of chunk precision indicators associated with respective chunks of the mixed-precision tensor; and
the plurality of chunks each have a predefined chunk size.

3. The computing device of claim 2, wherein:
the tensor processing operation is a matrix multiplication operation;
the hardware accelerator includes a plurality of dot product units configured to compute a respective plurality of dot products in parallel when performing the matrix multiplication operation; and
the dot product units have dynamically selectable input precisions that are configured to be selectable via precision control instructions.

4. The computing device of claim 3, wherein:
the dot product units are arranged in a plurality of dot product arrays; and
the hardware accelerator further includes a plurality of control engines that are each configured to control a respective dot product array at least in part by:
based at least in part on the chunk precision indicators, computing the respective precision control instructions of the dot product units included in the dot product array; and
transmitting the precision control instructions to the respective dot product units included in the dot product array.

5. The computing device of claim 2, wherein:
the mixed-precision tensor is stored in the memory in a plurality of shards that each include a respective plurality of the chunks; and
the hardware accelerator is further configured to receive the shards during separate shard processing iterations.

6. The computing device of claim 5, wherein one or more respective tensor region boundaries of the one or more first tensor regions differ from respective shard boundaries of the plurality of shards.

7. The computing device of claim 2, wherein the precision map includes a respective chunk precision indicator associated with each of the plurality of chunks included in the mixed-precision tensor.

8. The computing device of claim 2, wherein:
the first precision is a default precision of tensor elements included in the mixed-precision tensor; and
the precision map includes one or more chunk location indices of respective chunks that do not have the default precision.

9. The computing device of claim 2, wherein the hardware accelerator includes input memory that stores the one or more first tensor regions and the one or more second tensor regions in different respective non-interleaved memory regions.

10. The computing device of claim 9, wherein the hardware accelerator includes a tile control processor configured to:
receive respective addresses in the input memory of:
a chunk of the mixed-precision tensor;
an additional chunk of an additional tensor; and
the precision map;
based at least in part on the addresses, compute respective matrix element multiplication instructions for a plurality of control engines included in the hardware accelerator; and
transmit the matrix element multiplication instructions to the respective control engines.

11. A method for use with a computing device, the method comprising:
storing a mixed-precision tensor in memory, wherein the mixed-precision tensor includes:
one or more first tensor regions within which a plurality of first tensor elements have a first precision; and
one or more second tensor regions within which a plurality of second tensor elements have a second precision that differs from the first precision;
storing a precision map in the memory, wherein the precision map indicates the one or more first tensor regions and the one or more second tensor regions; and
at a hardware accelerator:
receiving the precision map from the memory;
receiving the one or more first tensor regions from the memory, as indicated by the precision map;
performing a tensor processing operation on the one or more first tensor regions in the first precision to obtain a first tensor processing output;
receiving the one or more second tensor regions from the memory, as indicated by the precision map;
performing the tensor processing operation on the one or more second tensor regions in the second precision to obtain a second tensor processing output; and
storing, in the memory, a combined tensor processing output including the first tensor processing output and the second tensor processing output.

12. The method of claim 11, wherein:
the precision map is stored as an array of chunk precision indicators associated with respective chunks of the mixed-precision tensor; and
the plurality of chunks each have a predefined chunk size.

13. The method of claim 12, wherein:
the tensor processing operation is a matrix multiplication operation;
the hardware accelerator includes a plurality of dot product units; and
the method further comprises, at the dot product units:
receiving respective precision control instructions; and
performing the matrix multiplication operation by computing a respective plurality of dot products in parallel at input precisions indicated in the precision control instructions.

14. The method of claim 13, wherein:
the dot product units are arranged in a plurality of dot product arrays;
the hardware accelerator further includes a plurality of control engines; and
the method further comprises, at each of the control engines, controlling a respective dot product array at least in part by:
based at least in part on the chunk precision indicators, computing the respective precision control instructions of the dot product units included in the dot product array; and
transmitting the precision control instructions to the respective dot product units included in the dot product array.

15. The method of claim 12, further comprising:
storing the mixed-precision tensor in the memory in a plurality of shards that each include a respective plurality of the chunks; and
receiving the shards at the hardware accelerator during separate shard processing iterations.

16. The method of claim 12, wherein the precision map includes a respective chunk precision indicator associated with each of the plurality of chunks included in the mixed-precision tensor.

17. The method of claim 12, wherein:
the first precision is a default precision of tensor elements included in the mixed-precision tensor; and
the precision map includes one or more chunk location indices of respective chunks that do not have the default precision.

18. The method of claim 12, further comprising storing the one or more first tensor regions and the one or more second tensor regions in different respective non-interleaved memory regions of input memory included in the hardware accelerator.

19. The method of claim 18, wherein:
the hardware accelerator includes a tile control processor; and
the method further comprises, at the tile control processor:
receiving respective addresses in the input memory of:
a chunk of the mixed-precision tensor;
an additional chunk of an additional tensor; and
the precision map;
based at least in part on the addresses, computing respective matrix element multiplication instructions for a plurality of control engines included in the hardware accelerator; and
transmitting the matrix element multiplication instructions to the respective control engines.

20. A computing device comprising:
memory storing:
a mixed-precision tensor stored in a plurality of chunks that each have a predefined chunk size, wherein the mixed-precision tensor includes:
one or more first tensor regions within which a plurality of first tensor elements have a first precision; and
one or more second tensor regions within which a plurality of second tensor elements have a second precision that differs from the first precision; and
a precision map indicating the one or more first tensor regions and the one or more second tensor regions, wherein the precision map is stored as an array of chunk precision indicators associated with respective chunks of the mixed-precision tensor; and
a hardware accelerator including a plurality of tiles, wherein the hardware accelerator is configured to:
receive the precision map from the memory;
receive the one or more first tensor regions from the memory, as indicated by the precision map;
perform a tensor processing operation on the one or more first tensor regions to obtain a first tensor processing output, wherein the tiles are configured to process respective chunks of the one or more first tensor regions at the first precision;
receive the one or more second tensor regions from the memory, as indicated by the precision map;
perform the tensor processing operation on the one or more second tensor regions to obtain a second tensor processing output, wherein the tiles are configured to process respective chunks of the one or more second tensor regions at the second precision; and
store, in the memory, a combined tensor processing output including the first tensor processing output and the second tensor processing output.
